(19) United States
(12) Patent Application Publication
(10) Pub. No.: US 2007/0188500 A1
(43) Pub. Date: Aug. 16, 2007

(54) Method and system for generation of presentation of house animation using multiple images of house

(76) Inventors: Alon Talmor, Haifa (IL); Rita Talmor, Haifa (IL); Eli Talmor, Haifa (IL)

Correspondence Address: Eli Talmor, Finland 7a, Haifa, 34989, omitted

(21) Appl. No.: 11/673,030

(22) Filed: Feb. 9, 2007

(30) Foreign Application Priority Data
Feb. 14, 2006 (IL) 173716

(51) Int. Cl. G06T 15/70

(52) U.S. Cl. 345/473

(57) ABSTRACT

The present invention relates to service-based generation of house presentation for real estate industry. More particularly, it relates to a system including user-generated photography and service provider using this photography to generate house presentation including general textual information and a number of animated video segments. In the context of this invention animated video segments include 3D visualization of house interior.

### FIELD AND BACKGROUND OF INVENTION

The present invention relates to the process of generation of house animated models and more particularly, but not exclusively to the software system capable of generating such models using house photo pictures.

More specifically the present invention relates to the process where the house owner or the seller provides the necessary imagery, uploads this information using Internet or other convenient infrastructure, the information is being pre-processed interactively by skillful expert of image visualization and following that by 3D proprietary software to generate realistic house interior, preferably allowing for virtual walk-around. The resulting software animated presentation being returned to the house owner or published online.

World Wide Web provides wide opportunities for house owners to advertise their property for sale or rent. Usually this information contains text, still imagery or video. The equipment used by the house owners is a commercially available camera and the level of skill of image/video acquisition is non-professional. Alternatively—professional video specialists may be hired to visit and generate video tour, but this is generally quite expensive, the availability is limited to certain towns in vicinity of video specialist.

The need exists to assist them in generating professionally looking house models to attract potential buyers.

For example software products named Tourweaver from Easypano Holdings Inc. China, or IPIX studio from IPIX Corp. USA, or ImageMaker360 in US describe the so-called image-stitching software that provides panoramic view and virtual tours using special fish-eye lens for wide-angle cameras. This solution is expensive for an average homeowner but may be applicable for realtors. Alternatively one may hire video photographer such as offered by numerous people, which is quite expensive and cumbersome. From the other hand—video imagery serious disadvantage is the video file size, which may make it prohibitive for Internet real-time viewing.

The house interior layout represents a drawing of a plan describing the dimensions of different rooms, doors, etc. It is a good starting point when you want to generate an animation of a new house project. But for already existing houses the layout information is not always available.

The table below summarizes the different methods of imagery generation together with its applicability, relative quality scale, and availability to the seller and relative cost. The last row describes the novel technique, which is the subject of present invention:

| | | | Relative | | |
|---|---|---|---|---|---|
| | | | Quality | | |
| Method | How | User | (1–5) | Availability | Cost |
| Stills | Self-service | Seller, | 2 | High | Low |
| | | realtor | | | |
| Panoramic | Buy | Realtor | 3 | Low | High |
| | hardware/ | | | | |
| | software | | | | |
| Video | Buy | Realtor | 5 | Very low | Very |
| | professional | | | | High |
| | service | | | | |
| Animation | Hire | New houses | 5 | Very low | Very |
| | professional | | | | High |
| | animator | | | | |
| New | Online Service | Seller, | 4 | High | Low |
| Invention | | realtor | | | |

Therefore it is advantageous to generate realistically looking animated house tours using a certain number of still images taken at visually interesting locations, while keeping the resulting file small and allowing viewing in real-time over the Internet at reasonable cost.

### SUMMARY OF THE INVENTION

Present invention provides software for generating animated video tours for real estate, suitable for existing houses.

It is the purpose of this invention to propose the method and system for generation of animated video using a series of stills images, whereas still images are generated by the client (seller or realty agent) and send via Internet or other convenient way.

The sequence of these still images is determined by the client (seller or realtor) to include the important views along the virtual tour around the house.

Although any digital camera can be used—to provide the best results in terms of maximal spatial coverage—the following must be undertaken:

The camera field-of-view has to be set as widest possible,

The picture has to be taken at the longest distance possible

Any digital camera can be used, including mobile phones. The appropriate results in terms of size vs. quality are obtained with resolution of 640*480 pixels in JPEG format.

Each shot filename should be descriptive for example:

LivingRoom_from_Kitchen.jpeg, Balcony_from_LivingRoom.jpeg, MasterBedroom_from_Corridor.jpeg, Corridor_from_EntranceDoor.jpeg.

The shot quality must appropriate and certain calibration elements must be present in the picture.

The output represents video file including stills pictures, with intermediate video animations and accompanied by descriptive audio. Video animation is accompanied by house 3D model showing the position of the person.

Since resulting video stream are to be downloaded using Internet—it is advisable to split the presentation into shorter segments, for example:

Kitchen-Living Room (back and forth)

Living Room-Balcony (back and forth)

Corridor-Bedrooms (back and forth)

Each segment is preceded by text information running until video is ready to display. In such fashion the user is not annoyed by the speed of the video download over the Web.

The animated video animations are 3D representations of the original stills image. This 3D representation includes nearly 180 degrees vision and realistic texture.

The segments and text information are incorporated into presentation that is downloaded by the client using the Internet.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1: is the simplified diagram showing business process flow between client and service provider.

FIG. 2: is the simplified diagram showing information content provided by client to service provider.

FIG. 3: is the simplified diagram showing the pre-processing of information by service provider.

FIG. 4: is the simplified diagram showing the geometric parameters of the camera and the scene.

FIG. 5: is the simplified diagram showing the key elements of the single frame segment.

FIG. 6: is the simplified diagram showing the key elements of the multiple frame segments.

FIG. 7: is the simplified diagram showing the content of animated video presentation received by client from service provider.

FIG. 8: is the simplified diagram showing the process of video presentation distribution by referral service.

FIG. 9: is the typical shooting data information available

### DESCRIPTION OF PREFERRED EMBODIMENTS

The principles and operation of a system according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

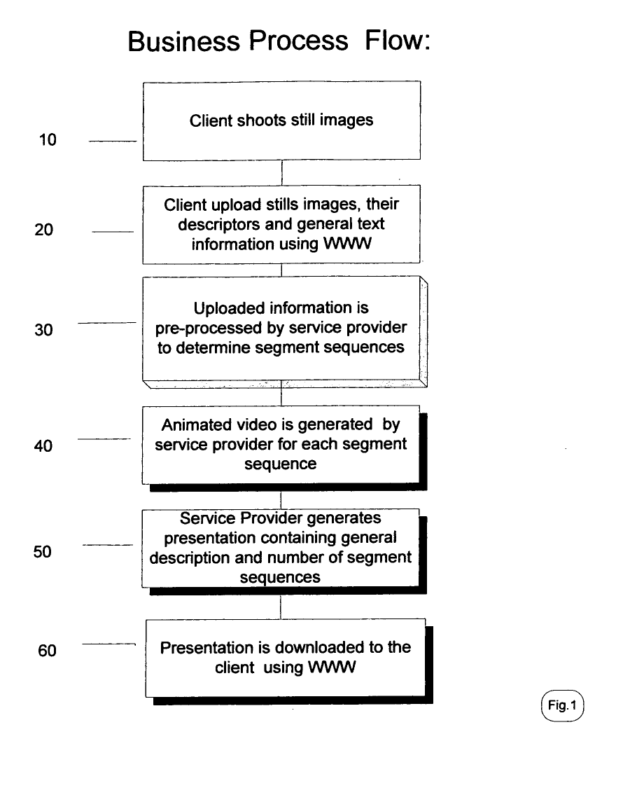

Reference is now made to FIG. 1 which illustrates the business process of online service for generating house presentation using stills imagery and textual description provided by the client. Client initiates the start 10 of business process by generating the sequence of still images of his/her choice. Following that 20 shows upload of the imagery and their description as well as general textual information using Internet or other convenient method. Uploaded information is pre-processed 30 by service provider to determine the animation segments, according to the content of the imagery supplied. Service provider 40, using the segment imagery pre-selected at step 30, generates animated video. The segments and the text are pre-arranged to form a presentation to be downloaded to the client 40 using Internet, published online or delivered using other convenient means.

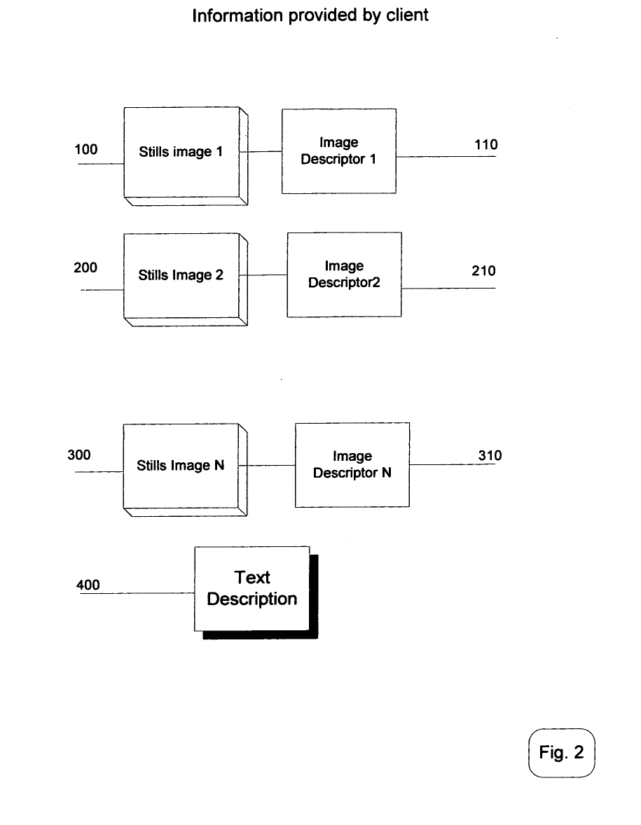

Reference is now made to FIG. 2, which illustrates the information sent by the client to the service provider. The information includes a number of stills images N determined by the client as described by 100,200,300 accompanied by their descriptors 110, 210 and 310. Also text description of the property 400 (address, number of rooms, area, etc.) to be sent to service provider and to be included in the presentation.

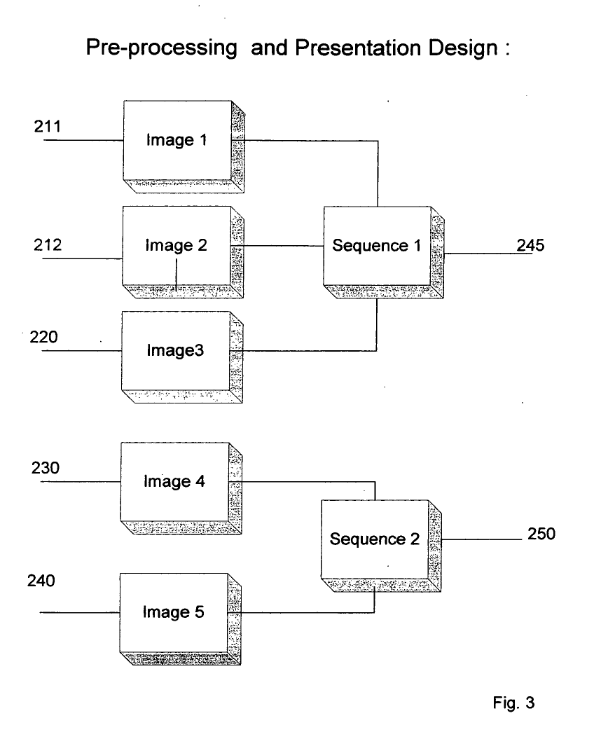

Reference is now made to FIG. 3, which illustrates the pre-processing performed by, or the service provider. The progress includes selection of images into segments such as images 211,212 and 222 into segment 245 and images 230,240 into segment 250, etc. The number of segments is therefore at least 1.

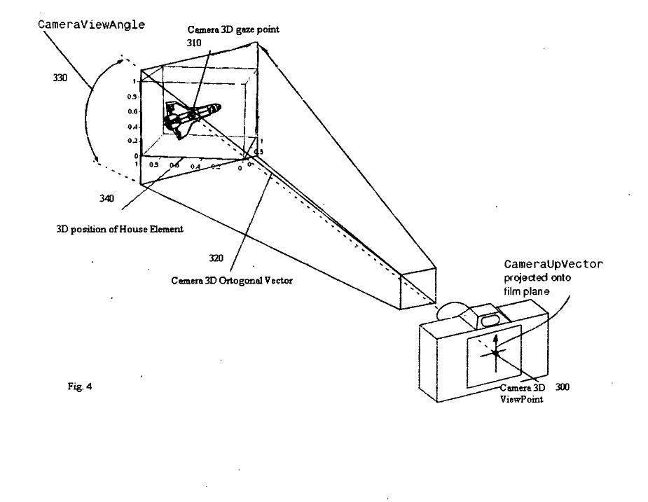

Reference is now made to FIG. 4,5,6 which illustrates the process of generation of animated video segment.

Animated video segment of house interior is generated using 2D photographs taken using commercial cameras. The geometry of picture-taking involved is described in FIG. 4.

Perspective properties reconstruction includes the usage of variable parameters defined in FIG. 4 as following: 300 describing Camera 3D view point, 310 describing Camera 3D gaze point, 320 describing Camera 3D orthogonal vector, 330 describing Camera view angle, 340 describing 3D Position of House Elements in the photo.

Camera parameters can be obtained using EXIF headers:

Digital cameras save JPEG (.jpg) files with EXIF (Exchangeable Image File) data. Camera settings and scene information are recorded by the camera into the image file. Examples of stored information are shutter speed, date and time, focal length, exposure compensation, metering pattern and if a flash was used.

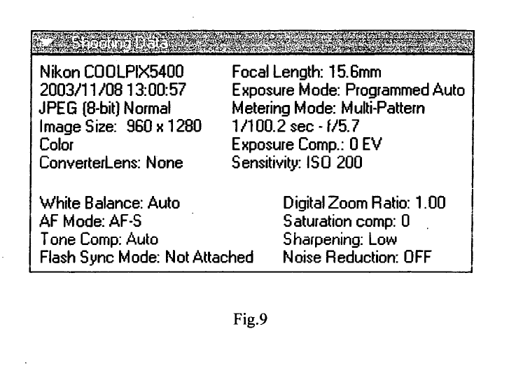

EXIF information is also embedded in original TIFF files. For example see FIG. 9:

Generating a 3D model from 2D photo/s is facilitated using prior knowledge of the modeled scene in terms of geometry of man-made structures. This knowledge is the contribution of human operator to the task. Usually man made structures consist of elements that are geometrically “simple” in nature. Walls, floors, ceilings etc are surfaces that are usually straight and/or orthogonal to each other. Therefore these “simple” elements are used to calibrate the imagery.

We will define these “simple” elements as Key House Elements.

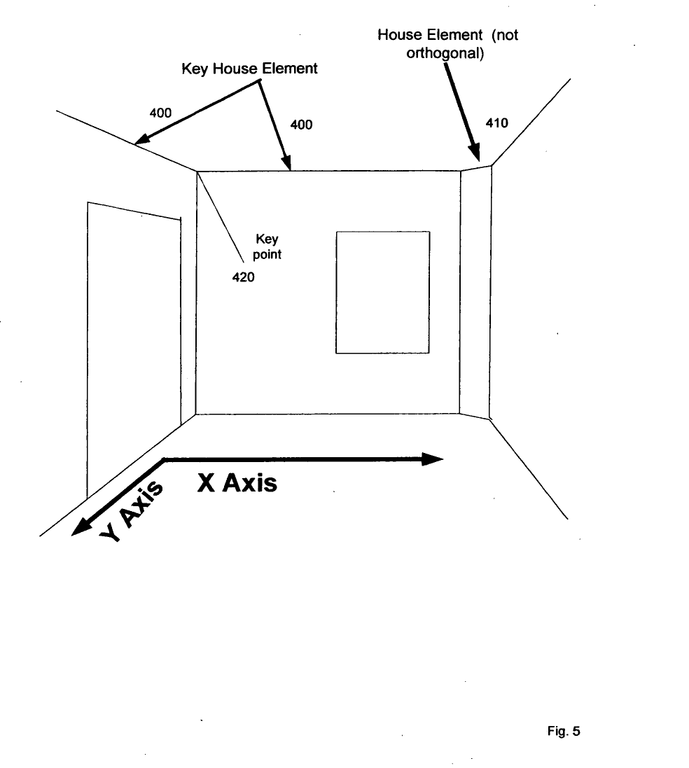

The reference is made to FIG. 5 that illustrates the concepts of Key House Elements being House Elements orthogonal to each other:

400 describes Key House Element is a house element that is orthogonal to the other house elements (i.e. is parallel to the X or Y Axis). The most common house element of this type is a Wall.

410 describes House Element—a house element that has some features that are helpful in solving the “Perspective” problem. Can be a curved wall, or a wall that does not lie on the X, Y axes, etc. . . .

420 describes Key points in house element are edges, vertices or intersection points between one house element and another, and common points between pictures.

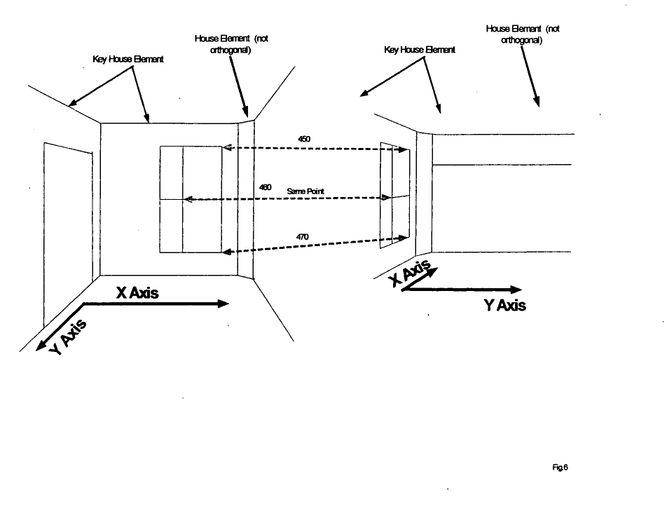

The reference is being made to FIG. 6 where the segment consists of multiple frames sharing some Key points. 450, 460 and 470 describe corresponding Key points in both pictures.

The following discussion specifies the conditions on pictures provided for successful 3D animation generation By identifying such “House Elements” one can reconstruct the perspective properties of the 3D model given that the number of elements and their nature is sufficient for this task. The number of Key House Elements may vary from case to case and are determined by human operator, for example:

1. For single-frame segment the number of Key House Elements required is at least 2, such as 2 perpendicular walls or 2 walls on both sides of the photo, where at least one wall contains a key point for the ceiling and a key point for the floor (or 2 or more photos of the same wall where at least one contains a key point of the floor and another contains a key point for the ceiling and the photos are connected by key points). The ceiling and the floor of the same wall are used to calculate scaling of the photo—the camera viewpoint.

In the case where some key points needed are not visible due to obscuration, then house elements such as beds, tables, chairs etc. that obscure them can be used for perspective calculation.

2. For multiple-frame segment where there are common elements between pictures—at least 3 points are required in order to obtain the difference in parameters as defined on FIG. 4.

3. Alternatively for multiple-frame segment—one can use common elements such as wall and one common point with another picture, given that another picture contains enough Key House Elements.

The quality of 3D modeling will be dependent on number of walls vertices—more vertices results in more accurate perspective.

Determining Key House Elements represents therefore a key contribution of human operator. In addition human operator may vary any stage in the process if the result is unsatisfactory.

Perspective properties reconstruction includes merging of this data to produce a model of all photographed areas.

The reconstruction technique is done using the following steps:
1. Arranging the photos into Segments—a Segment is a series of photos that are physically related (include some common elements of the model) or known to be related using prior knowledge of the model. This is done by human operator using a proprietary sorting software tool
2. All “Key House Elements” are identified and their coordinates in the photo are stored. This is done by human operator using a proprietary image tagging software tool in conjunction with Automatic Algorithm in the following manner:

The human operator is asked to pinpoint the location of “Key House Elements” as defined above.

An automatic algorithm of curve identification may be used to increase the key element selection speed.

Automatic Algorithm dedicated to determine Key Points may rely on Edge Detection or Line Detection or Shape Detection.

Finally—Human operator may accept or reject the decisions made by the computer.
3. The process of finding the “Perspective properties” of the segment is executed using automatic algorithm as following:

The multi perspective problem is an optimization problem in which multiple equations related to the geometry of the house elements must be solved. These equations describe the relationships between variable parameters of viewpoint, gaze point and camera orthogonal vector and may include:
a. The equation describing variable parameters so that all points on the wall belong to the same vertical plane parallel to the axis X or axis Y.
b. The equation describing variable parameters so that so that top right point of the wall is located exactly above lower right point of the wall, i.e. have equal X.Y values.
c. The equation describing variable parameters so that so that top left of the wall is located exactly above lower left point of the wall, i.e. have equal X.Y values.
d. If there are joint objects between pictures—then one must find the variable parameters that satisfy conditions a,b,c
e. If there are joint points between pictures—then one must find the variable parameters so that joint point have same coordinate (X, Y, Z)
The resulting system of equations may be solved analytically or iteratively.
Iterative solution is achieved by minimizing of computed error function between the assumed state of the key element (i.e. on X or Y axis) and the calculation resulting from system of equations.
The result is extracted 3D positions of the House Elements.
4. Building the 3D model using extracted 3D positions of the House Elements. This is performed using software modeling.
5. Adding texture by merging the real 2D photos on 3D model
6. Additional objects (tables, chairs, etc.) can be added to 3D model. For example—multiple angle shots of the same table will allow include table as 3D object in the animation.

Finding correlations between different photos subsequent classification if they belong to the same image can further optimize the process of pictures stitching. This process is not always performed well be computer and therefore human editor will review and confirm the results.

The resulting model build using the textures taken from the actual photos, involves human editor aligning walls, falls and ceiling.

For example human editor erases the images that do not belong to the wall, to preserve the geometry and to remove the furniture that is not important for the perspective buyer impression.

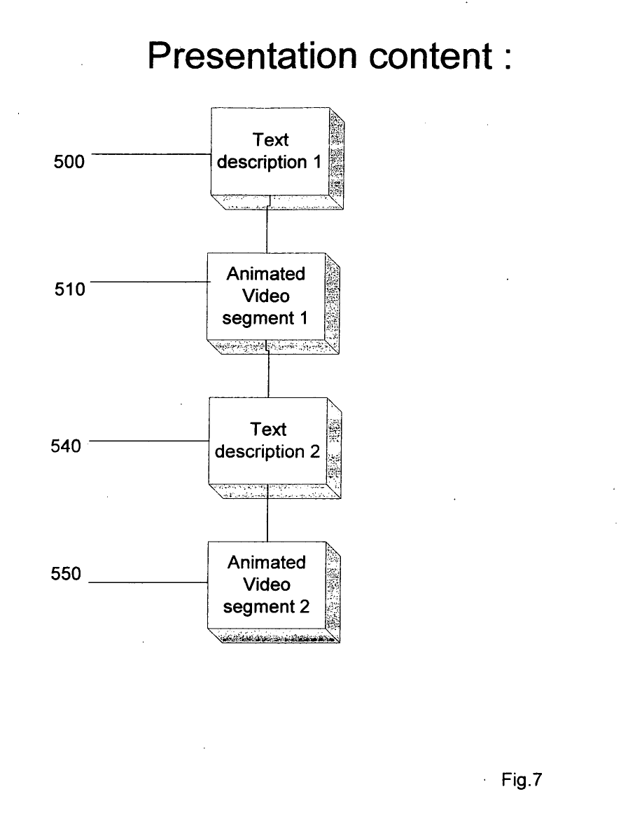

Reference is now made to FIG. 7, which illustrates the content of presentation produced by the service provider for the client. Each animated video segment is preceded by text description, so that text 500 is followed by video 510, followed by text 540 followed by video 550 and so on, to include all the segments produced.

The software techniques for animated video presentation may include Java applet, Activex or Macromedia Flash.

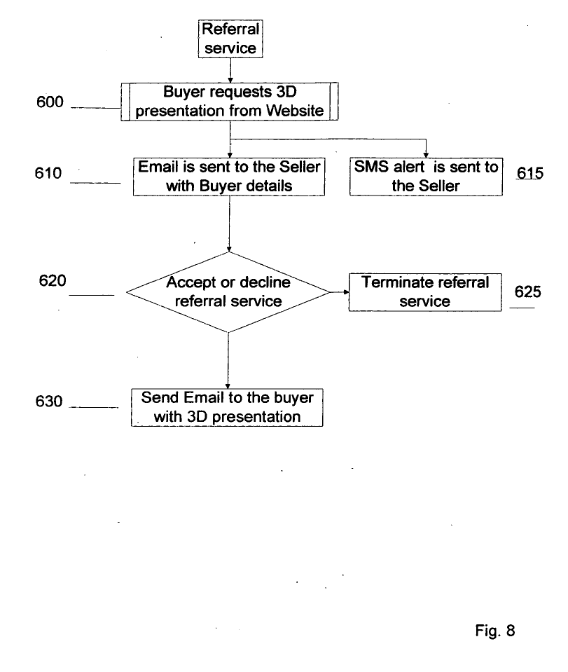

Reference is now made to FIG. 8, which illustrates presentation delivery to perspective buyer using off-line referral service. While browsing in the Website the buyer requests to see 3D presentation by submitting request 600. Email is sent with buyer details to the seller 610 accompanied with SMS alert 615. The buyer has the choice 620 to accept or decline referral service. If seller accepts—automatic email is sent to the buyer 630. If seller declines—the referral service is terminated.

Alternatively—the presentation can be published online.

What is claimed is:

1. The method of generation of computer presentation of the house of comprising:
a. Photographing views of interest in the house by the client
b. Uploading those photographs to the Service Provider
c. Generating house presentation including Animated Video of the house by the Service Provider.
d. Downloading of the house presentation including animated video to the client

2. The method of claim 1 where the photography is digital photography.

3. The method of claim 1 where uploading is performed over the Internet.

4. The method of claim 1 where house presentation includes text information.

5. The method of claim 1 where house presentation includes animated video.

6. The method of claim 1 where downloading of house presentation is performed over the Internet.

7. The method of claim 1 where house presentation includes at least one animated video segment.

8. The method of claim 1 where animated video is generated using imagery perspective information.

9. The system of generation of computer presentation of the house of comprising:
a. Photographing views of interest in the house by the client
b. Uploading those photographs to the Service Provider
c. Generating house presentation including Animated Video of the house by the Service Provider.
d. Downloading of the house presentation including animated video to the client

10. The system of claim 9 where the photography is digital photography.

11. The system of claim 9 where uploading is performed over the Internet.

12. The system of claim 9 where house presentation includes text information.

13. The system of claim 9 where house presentation includes animated video.

14. The system of claim 9 where downloading of house presentation is performed over the Internet.

15. The system of claim 9 where house presentation includes at least one animated video segment.

16. The system of claim 9 where animated video is generated using imagery perspective information.
